(19) United States
(12) Patent Application Publication
(10) Pub. No.: US 2020/0073554 A1
(43) Pub. Date: Mar. 5, 2020

(54) Applying Percentile Categories to Storage Volumes to Detect Behavioral Movement

(71) Applicant: International Business Machines Corporation, Armonk, NY (US)

(72) Inventors: Justin B. Doster, Sarasota, FL (US); Drew A. Peterson, Firestone, CO (US)

(21) Appl. No.: 16/121,832

(22) Filed: Sep. 5, 2018

(51) Int. Cl. G06F 3/06; G06F 11/34; G06F 11/30

(52) U.S. Cl. CPC G06F 3/0611; G06F 11/3485; G06F 3/0673; G06F 3/0629; G06F 11/3065

(57) ABSTRACT

A mechanism is provided in a data processing system comprising a processor and a memory, the memory comprising instructions that are executed by the processor to specifically configure the processor to implement a storage reporting and configuration engine. A volume performance data collection component collects a plurality of storage volume performance measures for a plurality of storage volumes within a storage environment. The plurality of storage volume performance measures comprise average input/output operations (IOPs), peak IOPs, average throughput, peak throughput, average latency, and peak latency. A volume performance percentile identification component assigns a percentile category to each performance measure for each volume to generate for each storage volume an average IOPs percentile category, a peak IOPs percentile category, an average throughput percentile category, a peak throughput percentile category, an average latency percentile category, and a peak latency percentile category. The storage reporting and configuration engine compares the percentile categories of the plurality of storage volumes and performs a configuration action on the plurality of storage volumes or the storage environment based on a result of the comparison.

### BACKGROUND

The present application relates generally to an improved data processing apparatus and method and more specifically to mechanisms for applying percentile categories to storage volumes to detect behavioral movement.

An increasing amount of processing power, memory capacity, storage capacity, and network data transmission bandwidth is available at decreasing cost. Consequently, the cost of managing stored data is becoming more expensive than the cost of the storage capacity. One way of dealing with this problem is to service multiple users with storage from a network storage system so that the management of the stored data can be consolidated and shared among the multiple users. The network storage system may also provide more efficient capabilities for sharing of the stored data among the multiple users, for moving less frequently accessed data to less expensive mass storage devices, and for providing backup and recovery for disaster protection.

Logical volume management relates to storage management by partitioning of storage of a storage system into logical volumes. A logical volume can then be assigned to a particular client or a group of clients, or a file system shared among a group of clients can be built on a logical volume. The partitioning of storage of a storage system into logical volumes typically involves arranging the storage into physical volumes, configuring volume groups of the physical volumes, and then configuring logical volumes within the volume groups. In general, a physical volume (PV) consists of one or many partitions (or physical extent groups) on a physical drive. A volume group (VG) is composed of one or more physical volumes, and contains one or more logical volumes. A logical volume is a unit of logical storage contained within a volume group.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system comprising a processor and a memory, the memory comprising instructions that are executed by the processor to specifically configure the processor to implement a storage reporting and configuration engine. The method comprises collecting, by a volume performance data collection component executing within the storage reporting and configuration engine, a plurality of storage volume performance measures for a plurality of storage volumes within a storage environment. The plurality of storage volume performance measures comprise average input/output operations (IOPs), peak IOPs, average throughput, peak throughput, average latency, and peak latency. The method further comprises assigning, by a volume performance percentile identification component executing within the storage reporting and configuration engine, a percentile category to each performance measure for each volume to generate for each storage volume an average IOPs percentile category, a peak IOPs percentile category, an average throughput percentile category, a peak throughput percentile category, an average latency percentile category, and a peak latency percentile category. The method further comprises comparing, by the storage reporting and configuration engine, the percentile categories of the plurality of storage volumes. The method further comprises performing, by the storage reporting and configuration engine, a configuration action on the plurality of storage volumes or the storage environment based on a result of the comparison.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts an example set of collected measures for logical volumes in accordance with an illustrative embodiment;

FIG. 2 depicts an example set of percentile categories for measures collected for logical volumes in accordance with an illustrative embodiment;

FIG. 3 is a block diagram depicting a storage reporting and configuration engine in accordance with an illustrative embodiment;

FIGS. 4A and 4B present a flowchart illustrating operation of a storage reporting and configuration engine in accordance with an illustrative embodiment

FIG. 5 is a flowchart illustrating operation of a mechanism for creating an IOPs volume comparative report in accordance with an illustrative embodiment;

FIG. 6 is a flowchart illustrating operation of a mechanism for creating a throughput volume comparative report in accordance with an illustrative embodiment;

FIG. 7 is a flowchart illustrating operation of a mechanism for creating a latency volume comparative report in accordance with an illustrative embodiment;

FIG. 8 depicts a cloud computing node according to an illustrative embodiment;

FIG. 9 depicts a cloud computing environment according an illustrative embodiment; and

FIG. 10 depicts abstraction model layers according to an illustrative embodiment.

### DETAILED DESCRIPTION

The illustrative embodiments provide a mechanism for applying percentile categories to individual logical volume input/output operations (IOPs), throughput, and latency point-in-time measurements. These measurements provide insight into how a logical volume is behaving relative to other logical volumes in a storage array. This allows a storage administrator to see which logical volumes would benefit most from behavioral storage systems, such as automated tiering. These measurements as relative percentile categories show if latency is a function of increased throughput or increased IOPs. The measurements also show which logical volumes in a disk array are experiencing contention when they see increased latency without corresponding increases in IOPs and throughput, etc. IOPs, throughput, cache hit ration, and latency are distinct measures reported by typical storage reporting tools. They can be extended with ratios to see I/O density, throughput density, or queue depth. Applying percentile categories to physical and derived measures allows the analyst to understand how those measures are moving and behaving relative to other logical volumes in the storage array.

Typical storage reporting tools allow the administrator to see, at a logical volume level, the average IOPs, throughput, and latency at a moment and across a period of time. Storage reporting tools also report the peak (or highest observed measure) within a period of time. For example, a given logical volume is currently performing at 120 IOPs, 12,000 KBs of throughput, and returning latency of 23 ms. The given logical volume averages 78 IOPs, 7,300 KBs of throughput, and 17 ms latency. At its peak in the period, the given logical volume executed 178 IOPs at 13,500 KBs of throughput, returning 78 ms latency. That is the most visibility the administrator can get out of existing storage reporting systems. They show physical measurements of the logical volume, but they do not give insight into how that logical volume is behaving relative to its peers, nor does it provide context to how that logical volume is moving over time relative to other logical volumes in the storage array.

The illustrative embodiments provide a storage reporting tool that places each performance measure at each point in time into a percentile category (e.g., quartile or quintile) and then tracks percentile movements over time. The storage reporting tool of the illustrative embodiments allows the analyst or administrator to see patterns of movement over time. In addition, the storage reporting tool combines movements of measures that signify behavior. For example, a given logical volume has IOPs, throughput, and latency at average in a sixth percentile category out of ten (50-60^{th} percentile). At peak, however, this logical volume latency jumps into the ninth percentile category (80-90^{th} percentile) with IOPs and throughput remaining in sixth percentile category. This indicates that the latency of the given logical volume is increasing relative to its peers without a corresponding increase in IOPs and/or throughput. This is a classic signal for contention. Furthermore, any logical volume containing extents from the same physical disks that are not seeing the condition will be the most likely source of the contention. If no other logical volumes physically connected are showing the behavior, then the system resources may be the source (e.g., cache dumping). Being able to identify these instances of abnormal behavior allow a storage administrator to better balance the overall array performance. This is just one example of predictive behavior. Any move out of a peer group (percentile category) in IOPs, throughput, latency, I/O density, throughput density, and queue depth is an indicator of behavior (where/why is a logical volume peaking) and then when those measurements move in relation to each other, it is an indicator of complex behavior.

Before beginning the discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

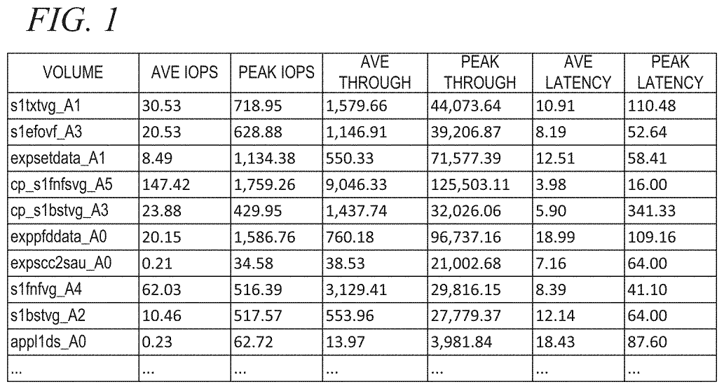

FIG. 1 depicts an example set of collected measures for logical volumes in accordance with an illustrative embodiment. In the depicted example, the collected measures include average input/output operations (IOPs), peak IOPs, average throughput, peak throughput, average latency, and peak latency. The collected measures may include other raw or derived measures not shown in FIG. 1, including cache hit ratio, I/O density, throughput density, queue depth, and the like. The collected measures may also collect read/write breakdowns of the IOPs, throughput, and latency measures, as well as cache hit/not hit, queue depth, I/O density, and throughput density.

In accordance with an illustrative embodiment, a storage reporting engine places the measures of each logical volume in a percentile category. In one embodiment, the storage reporting engine uses ten percentile categories as follows: 1: >0% and <=10%; 2: >10% and <=20%; 3: >20% and <=30%; 4: >30% and <=40%, 5: >40% and <=50%; 6: >50% and <=60%; 7: >60% and <=70%; 8: >70% and <=80%; 9: >80% and <=90%; 10: >90% and <=100%. The percentile categories represent where a metric for a given logical volume ranks relative to other logical volumes. For example, a logical volume with average IOPs in the 98^{th} percentile has a higher average IOPs value than 98% of other logical volumes. In alternative embodiments, the storage reporting engine may use other numbers of percentile categories, such as one hundred percentile categories, four quartiles, five quintiles, etc. Any number of percentile categories may be used within the spirit and scope of the illustrative embodiments.

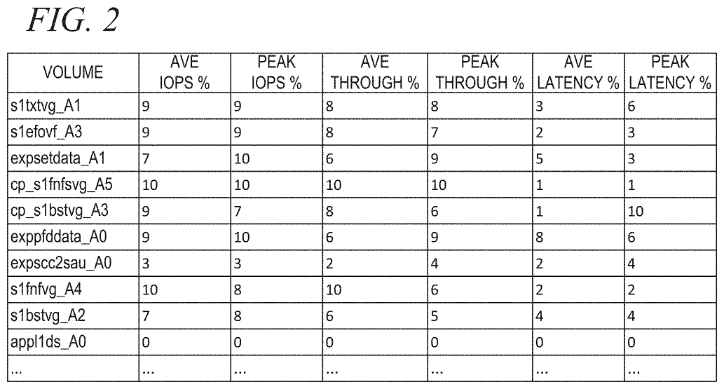

FIG. 2 depicts an example set of percentile categories for measures collected for logical volumes in accordance with an illustrative embodiment. Looking at the percentile categories, interesting patterns begin to emerge. For example, consider a first logical volume that is less busy at average than a second logical volume even though both are top performing at peak. The first logical volume is more variable. Also, the first logical volume may be peaking in both throughput and IOPs, even though both are top performing at peak. Also, the latency of the first logical volume may be much better at average than the second logical volume. Furthermore, a third logical volume may show a larger than normal peak in throughput between average and peak. These are examples of what individual measures can show.

In accordance with an illustrative embodiment, the storage reporting engine may combine measures. For example, the storage reporting engine may determine which logical volumes are experiencing an increase in latency without a corresponding increase in IOPs or throughput. The storage reporting engine may look for instances of IOPs and throughput percentile categories that are equal at average and peak but latency percentile categories that are higher.

Consider a logical volume for a database application. In such an application, latency is critical, workloads are likely small block random reads, and the application may benefit greatly from flash storage. Consider the IOPs percentile category is low for both average and peak. Throughput is low at both average and peak. However, unrelated to IOPs and throughput, latency is spiking up to one of the top percentile categories. Two things could likely cause this: either there is contention on the backend array that is providing the raw disks in this group or the logical volume is attached to a group that is having its cache filled by another logical volume in the same physical disk group and this logical volume has to queue while the cache is cleared. Therefore, if this logical volume is important, it should be moved to another physical disk group.

The movement of any of the measures against each other has meaning. For example, if latency is increasing at the same time that throughput is increasing without an IOPs increase, throughput is causing the latency increase and the system should increase parallelism through wider striping or change redundant array of independent disks (RAID) type to increase throughput, and it identifies where automated tiering will not help. Each of the measures forms a matrix with every change relative to another measure having a specific meaning. Each unique combination could have unique algorithms. A volume configuration component or storage environment configuration component may apply rules to configure storage based on the relative percentile categories of the logical volumes.

There is value to looking at the movement of measures across multiple arrays in the enterprise or multiple corporations in a managed service provider (MSP) scenario. For example, if the administrator wanted to deploy a flash tier with an MSP that had 20-30 arrays, the administrator would want to know which arrays would benefit the most from that flash and the utilization of IBM Easy Tier®, which is designed to automate data placement throughout the disk pool to improve the efficiency and performance of the storage system and is designed to relocate data (at the extent level) across up to three drive tiers automatically and without disruption to application. The answer is those arrays that show the most individual logical volumes with the largest percentile category jumps between average and peak. This can be determined using the percentile categories shown in FIG. 2.

Ultimately, a storage environment configuration component may use environment rules that specify how much should be apportioned based on the IOPs “peakiness” of an array. Percentile categories could be used to establish quality of service tiers and a volume configuration component may move data based on a defined quality-of-service (QoS) standard specified in volume rules. In other words, instead of being based on extent IOPs activity (as with IBM Easy Tier®), placement could be based on building momentum in a logical volume, switching between IOPs and throughput, increasing contention, etc., all in addition to how hot an extent is.

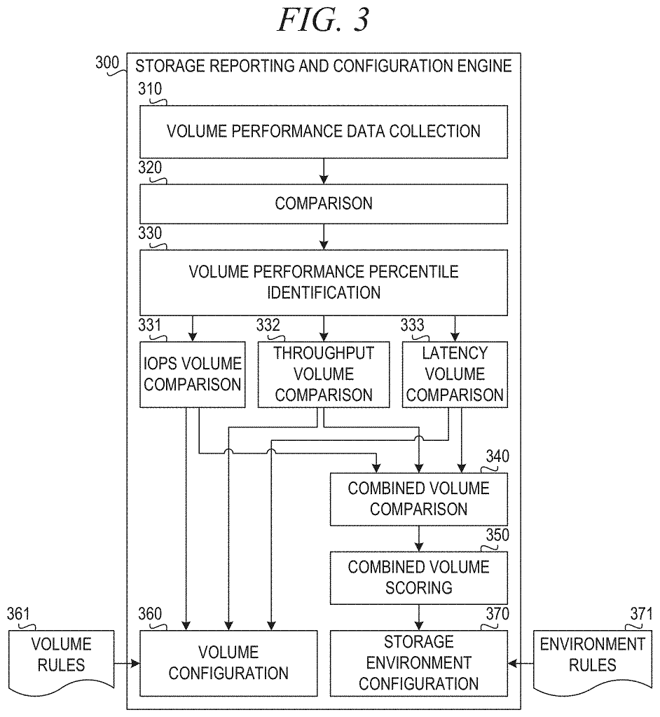

FIG. 3 is a block diagram depicting a storage reporting and configuration engine in accordance with an illustrative embodiment. Storage reporting and configuration engine 300 includes volume performance data collection component 310, which collects raw performance measures for individual logical volumes in a storage environment. The performance measures may include, for example, input/output operations (IOPs), throughput, and latency. In one embodiment, the performance measures include average IOPs, peak IOPs, average throughput, peak throughput, average latency, and peak latency. In a further embodiment, the performance measures may include other measures, such as cache hit ratio. In another embodiment, the performance measures may be broken down into read, write, and total. In yet another embodiment, volume performance data collection component 310 may extend the performance measures with ratios such as I/O density, throughput density, or queue depth.

Comparison component 320 compares the performance measures of the various logical volumes to rank them, and volume performance percentile identification component 330 assigns percentile categories to the logical volume performance measures. In one embodiment, volume performance percentile identification component 330 uses ten percentile categories as follows: 1: >0% and <=10%: 2: >10% and <=20%; 3: >20% and <=30%; 4: >30% and <=40%, 5: >40% and <=50%; 6: >50% and <=60%; 7: >60% and <=70%; 8: >70% and <=80%; 9: >80% and <=90%; 10: >90% and <=100%. The percentile categories represent where a metric for a given logical volume ranks relative to other logical volumes. For example, a logical volume with average IOPs in the 98^{th} percentile has a higher average IOPs value than 98% of other logical volumes. In alternative embodiments, volume performance percentile identification component 330 may use other numbers of percentile categories, such as one hundred percentile categories, four quartiles (1: >0% and <=25%; 2: >25% and <=50%; 3: >50% and <=75%; and 4: >75% and <=100%), five quintiles (1: >0% and <=20%; 2: >20% and <=40%; 3: >40% and <=60%; 4: >60% and <=80%, and 5: >80% and <=100%), etc. Any number of percentile categories may be used within the spirit and scope of the illustrative embodiments.

IOPs volume comparison component 331 groups and orders volumes based on percentile category rank for both average and peak IOPs to establish a baseline for each volume. IOPs volume comparison component 331 generates a volume and environment profile report, which is used to identify volumes with high and low activity and to determine an action to take. IOPs volume comparison component 331 identifies logical volumes for which the peak IOPs rank is higher than the average IOPs rank to determine volumes with significant difference in normal to peak activity and to determine if it is appropriate to migrate these logical volumes to a higher tier.

Throughput volume comparison component 332 groups and orders volumes based on percentile category rank for both average and peak throughput to establish a baseline for each volume. Throughput volume comparison component 332 generates a volume and environment profile report, which is used to identify volumes with high and low activity and to determine an action to take. Throughput volume comparison component 332 identifies logical volumes for which the peak throughput rank is higher than the average throughput rank to determine volumes with significant difference in normal to peak activity and to determine if it is appropriate to migrate these logical volumes to a higher tier.

Latency volume comparison component 333 groups and orders volumes based on percentile category rank for both average and peak latency to establish a baseline for each volume. Latency volume comparison component 333 generates a volume and environment profile report, which is used to identify volumes with high and low activity and to determine an action to take. Latency volume comparison component 333 identifies logical volumes for which the peak latency rank is higher than the average latency rank to determine volumes with significant difference in normal to peak activity and to determine if it is appropriate to migrate these logical volumes to a higher tier.

Volume configuration component 360 identifies actions to take on logical volumes based on volume rules 361. For example, volume rules 361 may specify that logical volumes having a peak IOPs rank a predetermined number of percentile categories higher than the average IOPs rank are to be migrated to a higher tier. Other such rules may exist in volume rules 361 to configure or reconfigure individual logical volumes based on the relative performance measure percentile categories. A volume and environment profile report combines results of the IOPs, throughput, and latency to develop a profile of the volumes.

Volume configuration component 360 uses that profile and volume rules 361 to determine what volumes belong in what tiers. Volume configuration component 360 also uses the volume and environment profile report over time to compare a particular volume to its historical trends to determine whether any actions, such as migration to other tiers or redistribution of data on the volume, may be appropriate. Volume configuration component 360 may treat inactive volumes as candidates for migration to an archive tier or for purging of data. Conversely, volume configuration component 360 may treat extremely highly active volumes, based on IOPs, throughput, and latency percentile categories, as candidates for technologies such as high performance flash. Elevated volumes may be candidates for commodity flash or standard disk technology. For logical volumes with normal activity, volume configuration component 360 may determine the best technology tier based on volume rules 361.

Combined volume comparison component 340 generates a combined volume comparative report, and combined volume scoring component 350 adds the average IOPs, throughput, and latency to determine a volume score on average for each volume. Combined volume scoring component 350 also adds the peak IOPs, throughput, and latency to determine a volume score on peak for each volume. Combined volume scoring component 350 then adds the average and peak scores and then divides by six to get the average of all scores to obtain the final volume score. Combined volume scoring component 350 creates a final summary comparative report grouping volumes based on their final score.

In one example embodiment, scores greater than a first threshold are grouped as extremely high activity, scores greater than a second threshold and less than or equal to the first threshold are grouped as elevated activity, scores greater than a third threshold and less than or equal to the second threshold are grouped as normal activity, scores greater than zero and less than or equal to the third threshold are grouped as low activity, and scores of zero are inactive volumes and grouped as inactive.

Storage reporting and configuration engine 300 may output the volume and environment profile report, the combined volume comparative report, and the final summary comparative report to the administrator.

Storage environment configuration component 370 may use the overall environment profile to determine how the storage environment as a whole performs and to identify performance characteristics used in determining procurement of future storage technologies. For example, based on the score of a set of volumes, storage environment configuration component 370 may determine, based on the score of a set of volumes, that they are the highest active volumes. Based on the latency, IOPs, and throughput of that group. Storage environment configuration component 370 may then determine what storage technology will provide the best and most cost effective performance for that workload. Thus, storage environment configuration component 370 may modify the configuration of the storage environment based on environment rules 371. For instance, storage environment configuration component 370 may procure new storage technologies to best serve the logical volumes in the storage environment.

The illustrative embodiments provide a storage reporting and configuration engine that assesses the volume performance relative to its peers. Each storage environment is different, not only by industry, such as financial, manufacturing, etc., but from each company or organization to each other. No two are alike. The storage reporting and configuration engine informs the storage manager how the volumes are performing within the environment, which makes executing potential performance changes faster and makes the best action more precise. The actions may not be as simple as tiering, but may indicate an issue with the application itself.

Other methods use a standard predetermined threshold and do not include a comparative analysis across performance characteristics (IOPs, throughput, and latency). The illustrative embodiments take the unique characteristics of the environment and use that as the method in conjunction with the combined performance profile to determine actions to be taken.

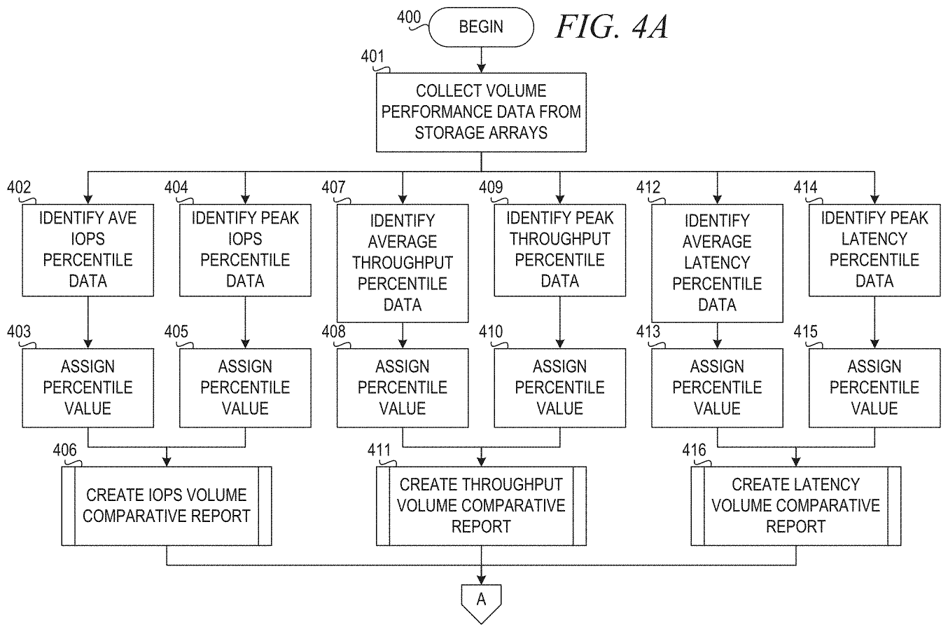

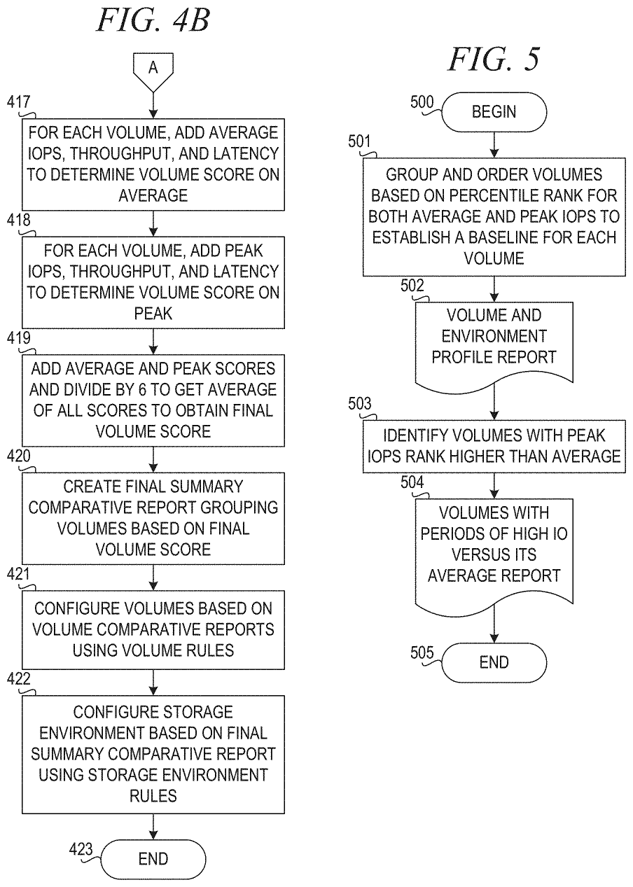

FIGS. 4A and 4B present a flowchart illustrating operation of a mechanism for storage reporting and configuration in accordance with an illustrative embodiment. Operation begins (block 400), and the mechanism collects volume performance data from storage arrays (block 401). The performance data may include, for example, input/output operations (IOPs), throughput, and latency. In one embodiment, the performance measures include average IOPs, peak IOPs, average throughput, peak throughput, average latency, and peak latency. In a further embodiment, the performance measures may include other measures, such as cache hit ratio. In another embodiment, the performance measures may be broken down into read, write, and total. In yet another embodiment, the mechanism may extend the performance measures with ratios such as I/O density, throughput density, or queue depth.

The mechanism identifies average IOPs percentile data (block 402) to generate average IOPs percentile ranges. In one embodiment, the mechanism generates ten percentile ranges or categories, although any number of percentile ranges may be used within the spirit and scope of the illustrative embodiments. The mechanism then compares each volume to percentiles and assigns a percentile value or category for average IOPs to each volume to generate average volume IOPs percentile rankings (block 403). The mechanism also identifies peak IOPs percentile data (block 404) to generate peak IOPs percentile ranges. The mechanism then compares each volume to percentiles and assigns a percentile value or category for peak IOPs to each volume to generate peak volume IOPs percentile rankings (block 405). Thereafter, the mechanism creates an IOPs volume comparative report (block 406). Operation of creating the IOPs volume comparative report will be described in further detail below with reference to FIG. 5.

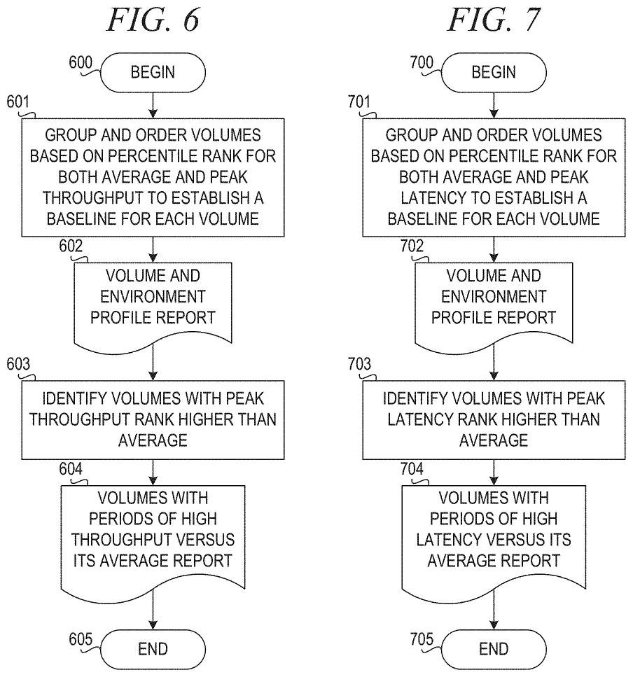

The mechanism identifies average throughput percentile data (block 407) to generate average throughput percentile ranges. The mechanism then compares each volume to percentiles and assigns a percentile value or category for average throughput to each volume to generate average volume throughput percentile rankings (block 408). The mechanism also identifies peak throughput percentile data (block 409) to generate peak throughput percentile ranges. The mechanism then compares each volume to percentiles and assigns a percentile value or category for peak throughput to each volume to generate peak volume throughput percentile rankings (block 410). Thereafter, the mechanism creates a throughput volume comparative report (block 411). Operation of creating the throughput volume comparative report will be described in further detail below with reference to FIG. 6.

The mechanism identifies average latency percentile data (block 412) to generate average latency percentile ranges. The mechanism then compares each volume to percentiles and assigns a percentile value or category for average latency to each volume to generate average volume latency percentile rankings (block 413). The mechanism also identifies peak latency percentile data (block 414) to generate peak latency percentile ranges. The mechanism then compares each volume to percentiles and assigns a percentile value or category for peak latency to each volume to generate peak volume latency percentile rankings (block 415). Thereafter, the mechanism creates a latency volume comparative report (block 416). Operation of creating the latency volume comparative report will be described in further detail below with reference to FIG. 7.

Turning to FIG. 4B, for each volume, the mechanism adds average IOPs, throughput, and latency to determine a volume score on average (block 417). For each volume, the mechanism adds peak IOPs, throughput, and latency to determine volume score on peak (block 418). The mechanism then adds the average and peak scores and divides by six to get an average of all scores to obtain final volume score (block 419).

The mechanism creates a final summary comparative report grouping volumes based on final volume score (block 420). In one example embodiment, scores greater than a first threshold are grouped as extremely high activity, scores greater than a second threshold and less than or equal to the first threshold are grouped as elevated activity, scores greater than a third threshold and less than or equal to the second threshold are grouped as normal activity, scores greater than zero and less than or equal to the third threshold are grouped as low activity, and scores of zero are inactive volumes and grouped as inactive. The mechanism configures volumes based on volume comparison reports using volume rules (block 421). The mechanism also configures the storage environment based on the final summary comparative report using storage environment rules (block 422). Thereafter, operation ends (block 423).

FIG. 5 is a flowchart illustrating operation of a mechanism for creating an IOPs volume comparative report in accordance with an illustrative embodiment. Operation begins (block 500), and the mechanism groups and orders volumes based on percentile rank for both average and peak IOPs to establish a baseline for each volume (block 501). The mechanism generates a volume and environment profile report (block 502). The mechanism identifies volumes with peak IOPs rank higher than its average IOPs rank (block 503). The mechanism generates a report identifying volumes with periods of high IO versus its average (block 504). Thereafter, operation ends (block 505).

FIG. 6 is a flowchart illustrating operation of a mechanism for creating a throughput volume comparative report in accordance with an illustrative embodiment. Operation begins (block 600), and the mechanism groups and orders volumes based on percentile rank for both average and peak throughput to establish a baseline for each volume (block 601). The mechanism generates a volume and environment profile report (block 602). The mechanism identifies volumes with peak throughput rank higher than its average throughput rank (block 603). The mechanism generates a report identifying volumes with periods of high throughput versus its average (block 604). Thereafter, operation ends (block 605).

FIG. 7 is a flowchart illustrating operation of a mechanism for creating a latency volume comparative report in accordance with an illustrative embodiment. Operation begins (block 700), and the mechanism groups and orders volumes based on percentile rank for both average and peak latency to establish a baseline for each volume (block 701). The mechanism generates a volume and environment profile report (block 702). The mechanism identifies volumes with peak latency rank higher than its average latency rank (block 703). The mechanism generates a report identifying volumes with periods of high latency versus its average (block 704). Thereafter, operation ends (block 705).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

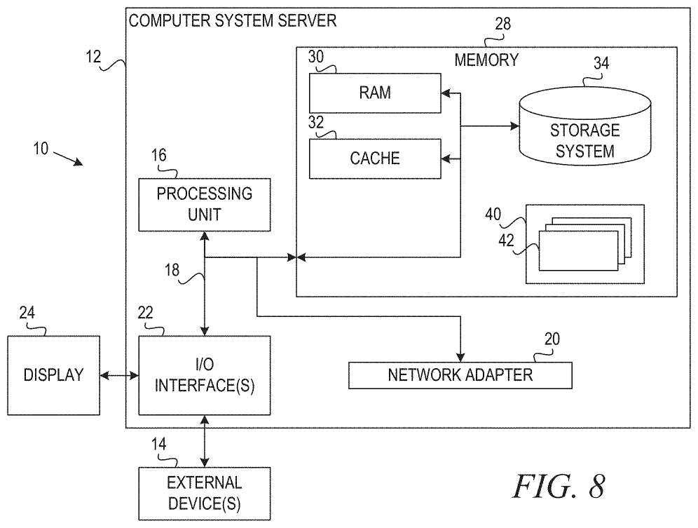

Referring now to FIG. 8, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

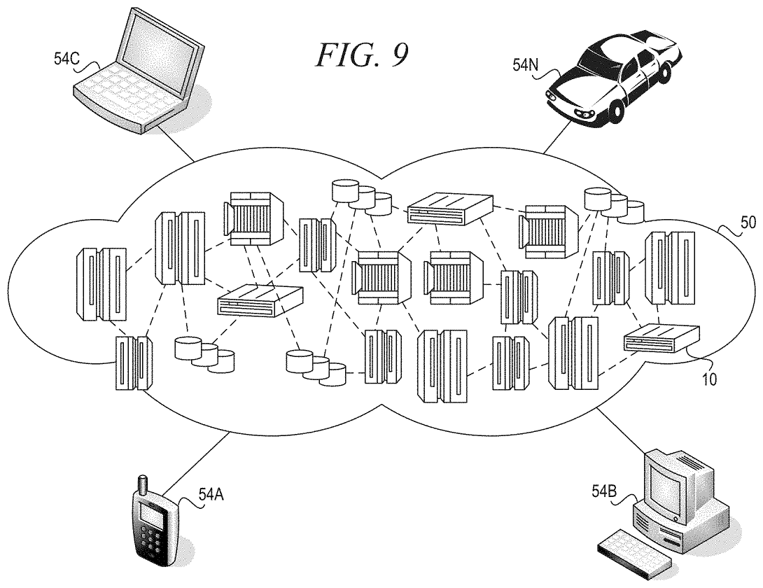

Referring now to FIG. 9, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

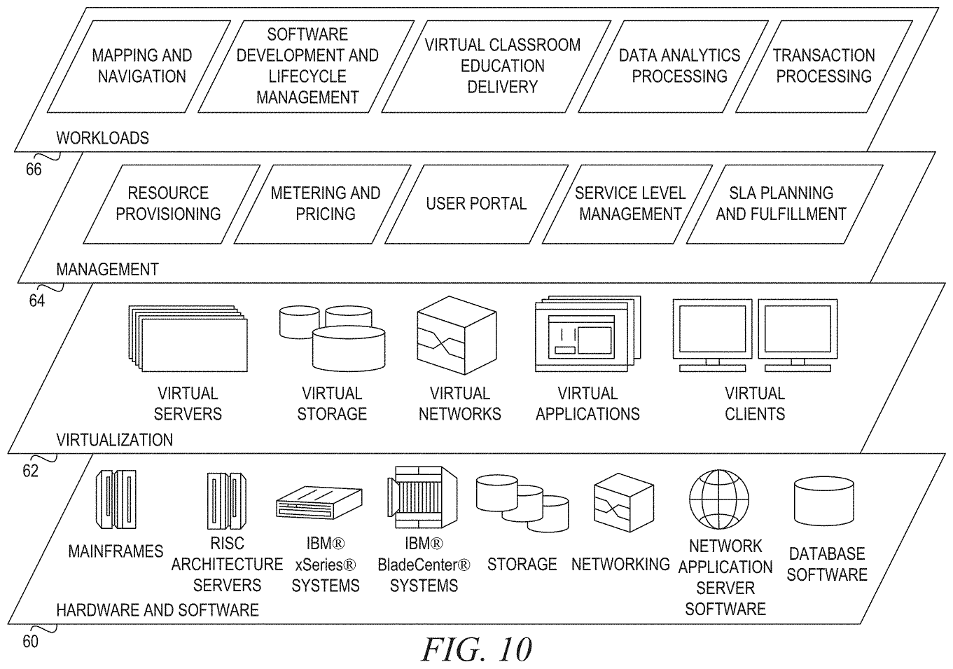

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSerics, pSeries, xSerics, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system comprising a processor and a memory, the memory comprising instructions that are executed by the processor to specifically configure the processor to implement a storage reporting and configuration engine, the method comprising:
collecting, by a volume performance data collection component executing within the storage reporting and configuration engine, a plurality of storage volume performance measures for a plurality of storage volumes within a storage environment, wherein the plurality of storage volume performance measures comprise average input/output operations (IOPs), peak IOPs, average throughput, peak throughput, average latency, and peak latency;
assigning, by a volume performance percentile identification component executing within the storage reporting and configuration engine, a percentile category to each performance measure for each volume to generate for each storage volume an average IOPs percentile category, a peak IOPs percentile category, an average throughput percentile category, a peak throughput percentile category, an average latency percentile category, and a peak latency percentile category;
comparing, by the storage reporting and configuration engine, the percentile categories of the plurality of storage volumes; and
performing, by the storage reporting and configuration engine, a configuration action on the plurality of storage volumes or the storage environment based on a result of the comparison.

2. The method of claim 1, wherein assigning the percentile category to each performance measure comprises categorizing each performance measure into one of ten percentile ranks.

3. The method of claim 1, wherein comparing the percentile categories of the plurality of storage volumes comprises identifying, by an IOPs volume comparison component executing within the storage reporting and configuration engine, logical volumes for which the peak IOPs rank is higher than the average IOPs rank.

4. The method of claim 1, wherein comparing the percentile categories of the plurality of storage volumes comprises identifying, by a throughput volume comparison component executing within the storage reporting and configuration engine, logical volumes for which the peak throughput rank is higher than the average throughput rank.

5. The method of claim 1, wherein comparing the percentile categories of the plurality of storage volumes comprises identifying, by a latency volume comparison component executing within the storage reporting and configuration engine, logical volumes for which the peak IOPs rank is higher than the average IOPs rank.

6. The method of claim 1, wherein the plurality of storage volume performance measures further comprises a cache hit ratio measure.

7. The method of claim 1, wherein the plurality of storage volume performance measures further comprises I/O density, throughput density, or queue depth.

8. The method of claim 1, wherein the plurality of storage volume performance measures comprise read/write breakdowns of average IOPs percentile category, a peak IOPs percentile category, an average throughput percentile category, a peak throughput percentile category, an average latency percentile category, and a peak latency percentile category.

9. The method of claim 1, wherein performing the configuration action comprises performing, by a volume configuration component executing within the storage reporting and configuration engine, the configuration action on at least one storage volume based on volume rules.

10. The method of claim 9, wherein the configuration action comprises migrating the at least one storage volume between storage tiers.

11. The method of claim 1, wherein comparing the percentile categories of the plurality of storage volumes comprises generating, by a combined volume scoring component executing within the storage reporting and configuration engine, a final volume score for each of the plurality of storage volumes.

12. The method of claim 11, wherein generating the final volume score comprises:
adding, for each storage volume within the plurality of storage volumes, the average IOPs, the average throughput, and the average latency to generate a volume score on average;
adding, for each storage volume within the plurality of storage volumes, the peak IOPs, the peak throughput, and the peak latency to generate a volume score on peak; and
adding the volume score on average and the volume score on peak and dividing by six to generate the final volume score.

13. The method of claim 12, wherein comparing the percentile categories of the plurality of storage volumes further comprises:
responsive to the final volume score for a given storage volume being greater than a first predetermined threshold, categorizing the given storage volume as extremely high activity;
responsive to the final volume score for the given storage volume being greater than a second predetermined threshold and less than or equal to the first predetermined threshold, categorizing the given storage volume as elevated activity;
responsive to the final volume score for the given storage volume being greater than a third predetermined threshold and less than or equal to the second predetermined threshold, categorizing the given storage volume as normal activity;
responsive to the final volume score for the given storage volume being greater than zero and less than or equal to the third predetermined threshold, categorizing the given storage volume as low activity; and
responsive to the final volume score for the given storage volume being zero, categorizing the given storage volume as inactive.

14. The method of claim 1, wherein performing the configuration action comprises performing, by a storage environment configuration component executing within the storage reporting and configuration engine, the configuration action on the storage environment based on environment rules.

15. The method of claim 14, wherein the configuration action comprises procuring new storage technologies for the storage environment.

16. A computer program product comprising a computer readable storage medium having a computer readable program stored therein, wherein the computer readable program, when executed on at least one processor of a data processing system, causes the data processing system to implement a storage reporting and configuration engine, wherein the computer readable program causes the data processing system to:
collect, by a volume performance data collection component executing within the storage reporting and configuration engine, a plurality of storage volume performance measures for a plurality of storage volumes within a storage environment, wherein the plurality of storage volume performance measures comprise average input/output operations (IOPs), peak IOPs, average throughput, peak throughput, average latency, and peak latency;
assign, by a volume performance percentile identification component executing within the storage reporting and configuration engine, a percentile category to each performance measure for each volume to generate for each storage volume an average IOPs percentile category, a peak IOPs percentile category, an average throughput percentile category, a peak throughput percentile category, an average latency percentile category, and a peak latency percentile category;
compare, by the storage reporting and configuration engine, the percentile categories of the plurality of storage volumes; and
perform, by the storage reporting and configuration engine, a configuration action on the plurality of storage volumes or the storage environment based on a result of the comparison.

17. The computer program product of claim 16, wherein performing the configuration action comprises performing, by a volume configuration component executing within the storage reporting and configuration engine, the configuration action on at least one storage volume based on volume rules, wherein the configuration action comprises migrating the at least one storage volume between storage tiers.

18. The computer program product of claim 16, wherein comparing the percentile categories of the plurality of storage volumes comprises generating, by a combined volume scoring component executing within the storage reporting and configuration engine, a final volume score for each of the plurality of storage volumes.

19. The computer program product of claim 16, wherein performing the configuration action comprises performing, by a storage environment configuration component executing within the storage reporting and configuration engine, the configuration action on the storage environment based on environment rules, wherein the configuration action comprises procuring new storage technologies for the storage environment.

20. An apparatus comprising:
a processor; and
a memory coupled to the processor, wherein the memory comprises instructions which, when executed by the processor, cause the processor to implement a storage reporting and configuration engine, wherein the instructions cause the processor to:
collect, by a volume performance data collection component executing within the storage reporting and configuration engine, a plurality of storage volume performance measures for a plurality of storage volumes within a storage environment, wherein the plurality of storage volume performance measures comprise average input/output operations (IOPs), peak IOPs, average throughput, peak throughput, average latency, and peak latency;
assign, by a volume performance percentile identification component executing within the storage reporting and configuration engine, a percentile category to each performance measure for each volume to generate for each storage volume an average IOPs percentile category, a peak IOPs percentile category, an average throughput percentile category, a peak throughput percentile category, an average latency percentile category, and a peak latency percentile category;
compare, by the storage reporting and configuration engine, the percentile categories of the plurality of storage volumes; and
perform, by the storage reporting and configuration engine, a configuration action on the plurality of storage volumes or the storage environment based on a result of the comparison.
